(19) United States
(12) Patent Application Publication
(10) Pub. No.: US 2006/0087935 A1
(43) Pub. Date: Apr. 27, 2006

(54) Tilt adjusting mechanism and disc drive using the same

(75) Inventors: Bin-Hai Guo, Shenzhen (CN); Chien-Ting Lo, Tu-Cheng (TW); Li-Ming Wan, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/260,755

(22) Filed: Oct. 27, 2005

(30) Foreign Application Priority Data
Oct. 27, 2004 (CN) 200420094577.5

(51) Int. Cl. G11B 7/00

(52) U.S. Cl. 369/44.32; 369/53.19

(57) ABSTRACT

A tilt adjusting mechanism for a disc drive is provided. The disc drive includes at least one guiding shaft for supporting and guiding a pickup head. The tilt adjusting mechanism includes a first part, a second part, and a third part. The tilt adjusting mechanism is rotatably mounted on the disc drive through the first part. The second part extends away from one end of the first part. The second part includes an eccentric hole engagingly receiving one end of said at least one guiding shaft. The third part extends away from the other end of the first part. A disc player having the tilt adjusting mechanism is also provided.

### BACKGROUND

1. Field of the Invention

The present invention is related to disc drives such as optical disc drives, and particularly to a tilt adjusting mechanism of a disc drive.

2. Related Art

A conventional disc drive, such as in a disc recording and/or reproducing device, generally includes a pickup head for reading information contained in a disc via a light beam, a driving mechanism for moving the pickup head along a radial direction of the disc, a turntable for the mounting of the disc thereon, a spindle motor for rotating the disc mounted on the turntable, and other components such as a circuit board. An angle between the light beam emitted from the optical pickup and a signal-recorded surface of the disc must always be maintained constant. In order to satisfy this requirement, a tilt adjusting mechanism is needed.

A conventional tilt adjusting mechanism is utilized to adjusting a motion plane of the pickup head so as to maintain the signal-recorded surface of the disc parallel to the motion plane of the pickup head. The pickup head is coupled to and supported by a pair of guide shafts, and is movable along the guide shafts. The guide shafts are mounted on a deck of a traverse module via holding members. The motion plane of the pickup head can be adjusted by adjusting a vertical position of the guide shafts relative to the deck. A typical tilt adjusting mechanism includes a cam member having a narrow spiral channel and a vertical guide block. By rotating the cam member using a wrench, the guide shaft is moved vertically by means of the vertical guide block. Thus, the motion plane of the pickup head is adjusted accordingly.

However, the above-mentioned tilt adjusting mechanism employ more than one component. This increases the manufacturing complexity of the tilt adjusting mechanism. Besides, the conventional adjusting mechanism can only adjust the vertical position of the guide shafts relative to the deck. Other adjustment of the guide shafts needs more components to achieve.

Therefore, a tilt adjusting mechanism that has a simple structure is needed.

### SUMMARY

A tilt adjusting mechanism for a disc drive is provided. The disc drive includes at least one guiding shaft for supporting and guiding a pickup head. The tilt adjusting mechanism includes a first part, a second part, and a third part. The tilt adjusting mechanism is rotatably mounted on the disc drive through the first part. The second part extends away from one end of the first part. The second part includes an eccentric hole engagingly receiving one end of said at least one guiding shaft. The third part extends away from the other end of the first part.

A disc player includes at least one guiding shaft, and at least one tilt adjusting mechanism mounted on an end of said at least one guiding shaft. The guiding shaft is mounted on the disc drive for supporting and guiding a pickup head. Each tilt adjusting mechanism includes a first part, a second part extending away from the first part, and a third part extending away from the other end of the first part. The second part includes an eccentric hole engagingly receiving the end of said at least one guiding shaft.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an isometric view of a disc drive in accordance with an exemplary embodiment of the present invention.

FIG. 2 is an inverted, isometric view of the disc drive of FIG. 1, showing a tilt adjusting mechanism in accordance with an exemplary embodiment of the present invention mounted therein.

FIG. 3 is an exploded view of the disc drive of FIG. 2.

FIG. 4 is an enlarged view of a circled portion IV of FIG. 2.

FIG. 5 is essentially an exploded view of parts shown in FIG. 4, but viewed from another aspect.

### DETAILED DESCRIPTION OF PREFERRED EMBODIMENTS

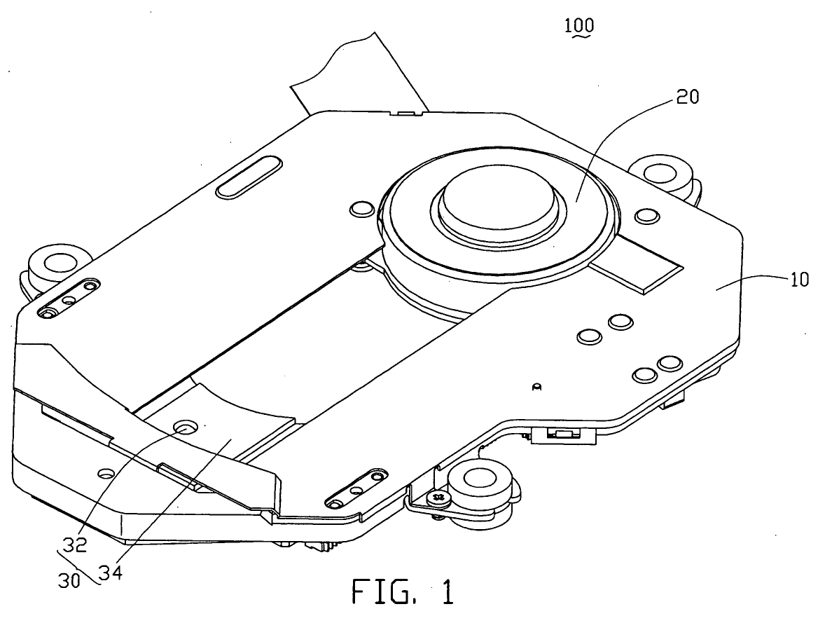

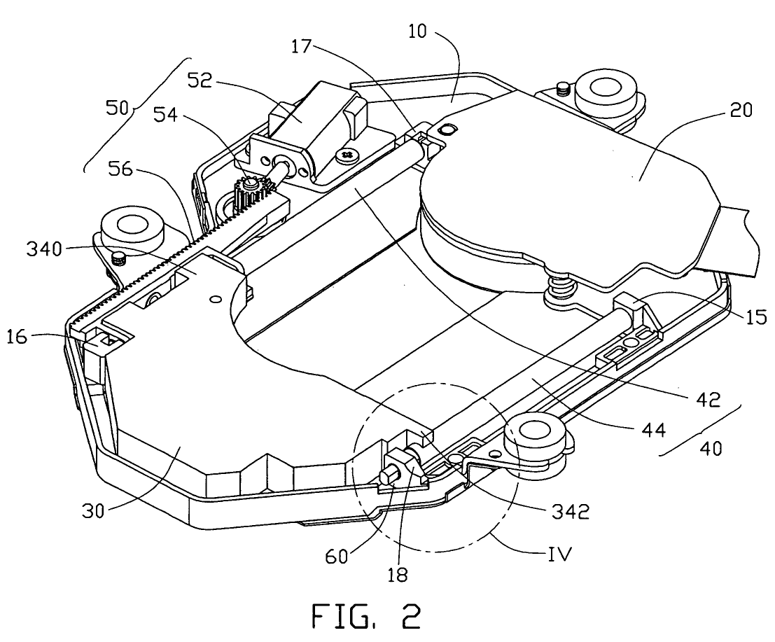

Referring to FIGS. 1 and 2, a disc drive 100 includes a deck 10, a turntable 20, a pickup head module 30, a guiding means 40, a driving means 50, and an adjusting mechanism 60.

The turntable 20 is mounted at a first side of the deck 10, and is for mounting of a disc thereon.

The pickup head module 30 is mounted at a second opposite side of the deck 10. The pickup head module 30 includes a pickup head 32, and a moving platform 34 for carrying the pickup head 32. The moving platform 34 includes a first holding portion 340 and a second holding portion 342. The pickup head module 30 is coupled to and thereby supported on the guiding means 40, with a first holding portion 340 and a second holding portion 342 being respectively movably engaged with the guiding means 40. The first holding portion 340 and the second holding portion 342 may be configured to be in the shape of a ring, a clamp, or any other suitable shape such that the pickup head module 30 can be firmly coupled to the guiding means 40.

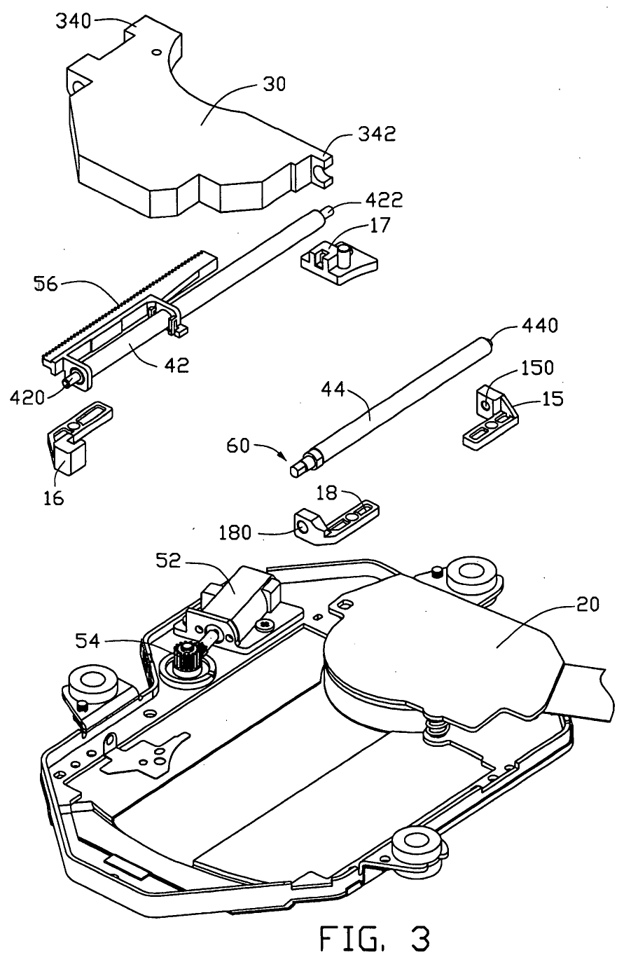

Referring to FIG. 3, the guiding means 40 includes a main guiding shaft 42 and an auxiliary guiding shaft 44. The main guiding shaft 42 and the auxiliary guiding shaft 44 are respectively mounted on two opposite lateral sides of the deck 10. Two opposite ends of the main guiding shaft 42 are respectively fixedly engaged with a first fixing member 16 and a second fixing member 17. One end of the auxiliary guiding shaft 44 is rotatably coupled to and supported by a first holding member 15. The other end of the auxiliary guiding shaft 44 is coupled to a second holding member 18 via the adjusting mechanism 60. The first fixing member 16, the second fixing member 17, the first holding member 15 and the second holding member 18 are fixedly mounted on corners of the deck 10 respectively.

Referring to FIG. 2, the driving means 50 is mounted on the deck 10, adjacent the main guiding shaft 42. The driving means 50 includes a driving motor 52, a gear set 54, and a gear rack 56. The gear rack 56 is meshed with and driven by the gear set 54, and is fixedly connected with the pickup head module 30. The driving motor 52 is for driving the gear set 54 to rotate; thereby driving the pickup head module 30 to move, jointly with the gear rack 56, along the guiding means 40.

The adjusting mechanism 60 is for adjusting a motion plane of the pickup head 32. One end of the adjusting mechanism 60 is fixedly connected with an end of the auxiliary guiding shaft 44. The other end of the adjusting mechanism 60 is coupled to and supported by the second holding member 18.

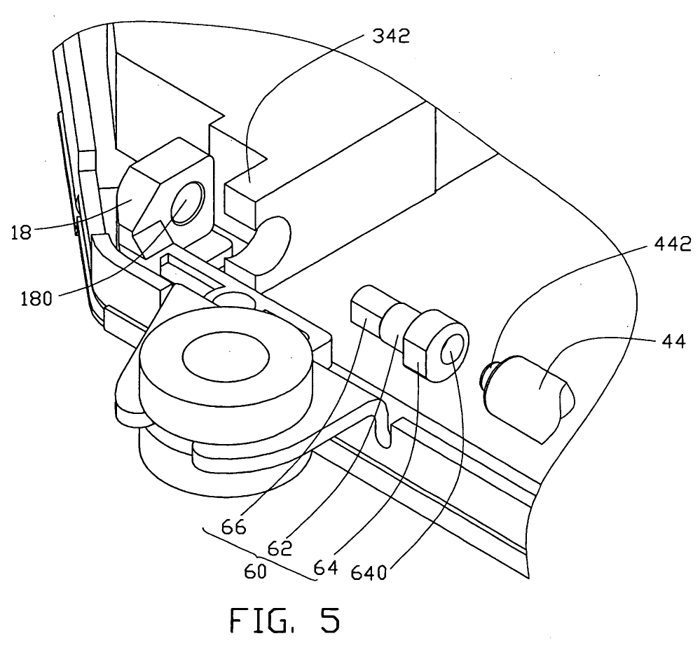

Referring to FIGS. 3 and 5, as described above, the main guiding shaft 42 includes a first end portion 420 and a second end portion 422. The main guiding shaft 42 is mounted on the deck 10, with the first end portion 420 being engaged with the first fixing member 16, and the second portion 422 being engaged with the second fixing member 17. The auxiliary guiding shaft 44 includes a first end portion 440 and an opposite second end portion 442. The first end portion 440 of the auxiliary guiding shaft 44 is rotatably received in a mounting hole 150 of the first holding member 15. Thus, the auxiliary guiding shaft 44 can be rotated under an external torsional force applied thereto. The second end portion 442 of the auxiliary guiding shaft 44 is firmly engaged with the adjusting mechanism 60. The second holding member 18 includes a through hole 180. The adjusting mechanism 60 extends through the through hole 180.

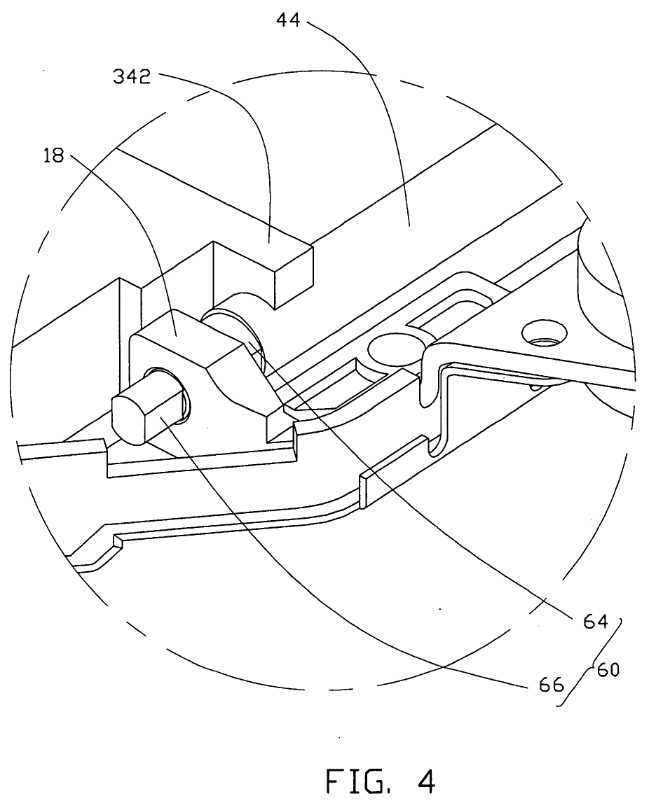

Referring to FIGS. 4 and 5, the adjusting mechanism 60 includes a first part 62, a second part 64 extending away from one end of the first part, and a third part 66 extending away from the other end of the first part. The first part 62, the second part 64, and the connecting part 66 are generally formed as a single piece. The second part 64 defines an eccentric hole 640. The second end portion 442 of the auxiliary guiding shaft 44 is securely engaged in the eccentric hole 640, such that the auxiliary guiding shaft 44 can be rotated jointly with the adjusting mechanism 60. The second end portion 442 of the auxiliary guiding shaft 44 may be interferingly engaged in the eccentric hole 640. Alternatively, the second end portion 442 of the auxiliary guiding shaft 44 can be in threaded engagement with the second part 64. A central axis of the eccentric hole 640 is nonaligned relative to a central axis of the first part 62.

The second part 64 is substantially cylindrical. An outer diameter of the second part 64 is greater than an inner diameter of the through hole 180 of the second holding member 18. The third part 66 has a flat portion, such that the third part 66 can be easily clamped by a wrench or other suitable means. An outer diameter of the third part 66 is smaller than the inner diameter of the through hole 180. The first part 62 is substantially cylindrical. An outer diameter of the first part 62 is slightly smaller than the inner diameter of the through hole 180. When the adjusting mechanism 60 is mounted on the deck 10, the third part 66 extends through the through hole 180 of the second holding member 18, and the first part 62 is received in the through hole 180.

When the third part 66 is rotated using a wrench, the second part 64 is driven to revolve the auxiliary guiding shaft 44. The auxiliary guiding shaft 44 is thereby rotatingly moved up and down. Thus, the motion plane of the pickup head module 30 can be precisely adjusted by way of the eccentric motion of the auxiliary guiding shaft 44. Besides, the auxiliary guiding shaft 44 is adjustable horizontally and vertically relative to the deck 10 at the same time due to driven motion of the auxiliary guiding shaft 44.

In another exemplary embodiment, the disc drive 100 may further include additional, similar tilt adjusting mechanisms. For instance, such tilt adjusting mechanism may also be configured at any one or more of the first and second end portions 420, 422 of the main guiding shaft 52, and the first end portion 440 of the auxiliary guiding shaft 44.

The embodiments and methods described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A tilt adjusting mechanism for a disc drive, said disc drive comprising at least one guiding shaft for supporting and guiding a pickup head, the tilt adjusting mechanism comprising:
a first part, wherein the tilt adjusting mechanism is rotatably mounted on the disc drive through the first part;
a second part extending away from one end of the first part, the second part comprising an eccentric hole engagingly receiving one end of said at least one guiding shaft; and
a third part extending away from the other end of the first part.

2. The tilt adjusting mechanism as claimed in claim 1, wherein the first part and the second part are cylindrical.

3. The tilt adjusting mechanism as claimed in claim 1, wherein the third part is substantially rectangular.

4. The tilt adjusting mechanism as claimed in claim 1, wherein the first part, the second part, and the third part are integrally formed.

5. The tilt adjusting mechanism as claimed in claim 1, wherein the disc drive comprises a holding member fixed on the disc drive, for rotatably supporting the first part.

6. The tilt adjusting mechanism as claimed in claim 5, wherein the holding member comprises a through hole, the first part being inserted the through hole, the third part protruding out through the through hole.

7. A disc player comprising:
a deck of said disc player;
means installed on said deck for rotatably supporting a disc in said disc player;
a pickup head for retrieving information from said disc supported in said disc player;
at least one guiding shaft movably installed beside said deck so as to movably support said pickup head beside said deck and guide movement of said pickup head relative to said deck; and
an adjusting mechanism installed at one end of said at least one guiding shaft and user-drivably movable relative to said deck, movement of said adjusting mechanism leading to position adjustment of said at least one guiding shaft simultaneously along at least two directions relative to said deck.

8. The disc player as claimed in claim 7, wherein said movement of said adjusting mechanism is user-drivable rotation of said adjusting mechanism beside said deck, and said at least two directions along which said position adjustment of said at least one guiding shaft is led due to said movement of said adjusting mechanism comprise a vertical direction to said deck and a parallel direction to said deck.

9. The disc player as claimed in claim 7, wherein said adjusting mechanism comprises a first part to be supported on said deck, a second part extending from said first part to engage with said one end of said at least one guiding shaft and a third part extending from said first part for applying of user driving, said second part further comprises an eccentric hole to engage with said one end of said at least one guiding shaft so as to result in said position adjustment of said at least one guiding shaft.

10. The disc player as claimed in claim 9, wherein said first part and said second part are cylindrical.

11. The disc player as claimed in claim 9, wherein said third part is substantially rectangular.

12. The disc player as claimed in claim 9, wherein said first part, said second part and said third part are integrally formed.

13. The disc player as claimed in claim 9, further comprising a holding member fixable to said deck for rotatably supporting said first part via a through hole thereof.

14. A disc player comprising:
means for rotatably supporting a disc in said disc player;
a pickup head for retrieving information from said disc supported in said disc player by said means;
at least one guiding shaft movably supported in said disc player so as to further support said pickup head beside said disc supported in said disc player and guide movement of said pickup head relative to said disc; and
an adjusting mechanism installed at one end of said at least one guiding shaft and user-drivably movable relative to said disc for resulting in position adjustment of said at least one guiding shaft, a supported distance of said at least one guiding shaft in said disc player comprising a length of said at least one guiding shaft and another length of said adjusting mechanism.

15. The disc player as claimed in claim 14, further comprising a first holding member fixable in said disc player for supporting another end of said at least one guiding shaft and a second holding member fixable in said disc player for rotatably supporting said adjusting mechanism, and a distance between said first and second holding members substantially equal to said supported distance of said at least one guiding shaft.
